(19) United States
(12) Patent Application Publication
(10) Pub. No.: US 2004/0013761 A1
(43) Pub. Date: Jan. 22, 2004

(54) Device for treating particulate material

(76) Inventor: Herbert Huttlin, Lorrach (DE)

Correspondence Address: ST. ONGE STEWARD JOHNSTON & REENS, LLC, 986 BEDFORD STREET, STAMFORD, CT, 06905-5619, US

(21) Appl. No.: 10/427,008

(22) Filed: Apr. 30, 2003

Related U.S. Application Data
(63) Continuation of application No. PCT/EP01/11797, filed on Oct. 11, 2001.

(30) Foreign Application Priority Data
Oct. 31, 2000 (DE) 100 54 557.2

(51) Int. Cl. B29B 13/00

(52) U.S. Cl. 425/445

(57) ABSTRACT

A device (10) for treating particulate material has a bottom (14) made of mutually overlapping guide plates (16-19), between which slots (21-24) are formed. The slots (21-24) are arranged in such a way, that two opposite flows directed toward each other are produced, which meet each along a central breaking-up zone (26). Two spray nozzles (28, 30) are arranged at opposite ends of the breaking-up zone (26). The slots (21-24) run so that as to be let together in the region of each nozzle (FIG. 1).

### CROSS-REFERENCE TO RELATED APPLICATION

This application is a continuation of copending international patent application PCT/EP01/11797 filed on Oct. 11, 2001 and designating the U.S., which was not published under PCT Article 21(2) in English, and claims priority of German patent application DE 100 54 557.2 filed on Oct. 31, 2000, which is incorporated herein by reference.

### BACKGROUND OF THE INVENTION

The invention relates to a device for treating particulate material, having a process chamber for receiving and treating the material with process air, and a bottom in the process chamber made of mutually overlapping guide plates, between which slots are formed to feed the process air with a substantially horizontal movement component into the process chamber, the slots being arranged in such a way that two opposite flows directed toward each other are produced, which meet each other along a breaking-up zone and, in the region of the breaking-up zone, two spray nozzles are provided.

A device of this type is disclosed by EP 1 025 899 A1 from the applicant.

Devices of this type are used to dry, granulate or coat a particulate material.

A gaseous medium, what is known as process air, is introduced into the process chamber via the bottom and, during the process, enters the process chamber directed approximately horizontally through the numerous slots between the mutually overlapping guide plates.

In the case of granulating or coating, appropriate adhesive or coating media are sprayed via spray nozzles onto the material accommodated in the process chamber and moved through the process air.

In the case of granulating, dust-fine particles are then bonded to form larger agglomerates, namely to form the granules. In the case of coating, for example in the case of coating tablets, the intention is for the latter to be provided with the most uniformly thick and regular coating layer.

In connection with the application of adhesive or coating media, the positioning of the spray nozzles within the device acquires a substantial task. In the case of the known device mentioned at the beginning, the spray nozzles are arranged approximately centrally in the course of the breaking-up zone.

In practical operation, it has now been established that it is worthwhile achieving a homogeneous product movement which covers all the volume areas and which is to be maintained even when extremely low quantities of process air are introduced.

The more homogeneous the product movement is and the better the co-action of air/product movement and spraying, the further can the treatment result be improved.

In particular in the region of the nozzles, specific fluidization of the product is to be able to take place which, for example during granulation, rules out large agglomerates being produced unintentionally, or the adhesion of product particles or agglomerates taking place in the region of the nozzle.

Furthermore, there should be the most homogeneous and re-producible flow relationships possible, which permit scaling up without difficulty.

In particular in the pharmaceutical and in the foodstuffs industry, such plants are often initially operated on a small scale but then, depending on the throughput of the product, scaling up, that is to say treatment in a substantially larger device, then has to be carried out, the intention being when scaling up for completely new flow relationships not to be produced when a change is made from a device for a small batch to a device for a large or very large batch.

In the device cited at the beginning, the guide plates are constructed as plates laid one above another, between which rectilinear slots or gaps for the passage of the process air are formed, the slots extending along secants of the circular bottom. As viewed circumferentially around the bottom, there is therefore a graduation of the guide plate surfaces in the manner of a staircase, which makes a correspondingly complexly shaped stepped flange necessary for the container, under which the guide plates are mounted.

It is therefore an object of the present invention to develop a device of the type mentioned at the beginning with the effect that, by using a simple construction, an optimum treatment result can be achieved, and that scaling up can also be carried out without difficulty.

### SUMMARY OF THE INVENTION

According to the invention, this object is achieved in that the two spray nozzles are arranged at the opposite ends of the breaking-up zone, and wherein the slots in the outer circumferential region are matched to the outer contour of the process chamber and, as viewed radially inward, gradually approach the contour of the breaking-up zone, the slots running so as to be led together in the region of each nozzle.

These measures have the advantage that, in the region of the spray nozzles, there is a concentration of slots per square unit, through which concentration more process air can enter and a considerably more intense fluidization of the moved product results around the nozzles.

As a result of arranging the two spray nozzles at opposite outer ends of the breaking-up zone, in combination with the concentration of the slots together in this region, a scaling up can be carried out without difficulty. In case of an enlarged plant, it is not longer compulsory to provide a greater number of spray nozzles. It has been established that with two nozzles arranged at opposite outer ends of the breaking-up zone, in conjunction with leading the slots together in the region of the nozzle, scaling up can be carried out without difficulty. This is to be seen as an advantage which is to be particularly emphasized.

From a production point of view, it is then possible for the respective topmost guide plate to be connected continuously with a planar gap spacing to a lower flange end of the product holder. This was impossible in the case of the construction with the air gaps along secants, since here the outermost top-most plate was still only a circular section, so that corresponding stepping of this flange was then absolutely necessary in order to have available the respective equal gap spacing in order to supply the slots.

Thus, the aforementioned features result in more intense specific fluidization of the product in the region of the spray nozzles, no stepping of the basic flange of the container is necessary, and the system can be defined with two spray nozzles when scaled up.

Matching the slots to the outer contour of the process chamber and step by step to the contour of the breaking-up zone has the advantage that, at the outer circumferential edge, in which the slots approximately correspond to the contour of the outer contour of the bottom, no material is deposited or baked on in the transition from the vertical container wall to the approximately horizontal bottom, and the air movement is gradually pushed together or concentrated in the direction of the central breaking-up zone, so that there quite specifically aligned opposed flows which meet each other are produced, which are then deflected upward in the breaking-up zone after meeting each other.

This likewise contributes further to improving the treatment result.

In a further embodiment of the invention, if the outer contour of the process chamber is annular, the contour of the breaking-up zone is rectilinear and runs along a diameter of the process chamber, and the slots gradually outwardly approach the circumcircle of the process chamber, while they gradually radially inwardly approach the rectilinear breaking-up zone along the diameter.

Given this geometry, this results in the previously mentioned excellently controlled and uniform product guidance in the direction of the breaking-up zone.

In a further embodiment of the invention, the slots are led together approximately tangentially in the region of a spray nozzle.

This measure has the advantage that the concentration of the slots in the region of the spray nozzle takes place in a very gently contoured linear way, which is introduced harmoniously into the further course of the contour of the slots.

In the case of the exemplary embodiment mentioned previously and having the circular process chamber, the spray nozzles are located diametrically opposite at outer ends of the circumcircle of the process chamber. The outermost slot is therefore still circular, the slots lying radially further in are then formed by ellipses which become flatter and flatter and at whose opposite main vertices the nozzles are arranged, that is to say all the ellipses run together in the region of these vertices.

In a further embodiment of the invention, the slots in the region of a spray nozzle have rectilinear sections which run parallel to the breaking-up zone.

This measure has the considerable advantage that the slots in these end sections run in parallel and arranged at a distance from one another to the breaking-up zone.

As a result of this arrangement, in the region of the spray nozzles, powerful opposed flows are formed by the end sections running rectilinearly and parallel to each other, summing the volumes of process air passing through the slots in this section, said flows then meeting each other in opposite directions and forming an intensely formed vertical flow zone in the region of the spray nozzles, so that the medium sprayed by the spray nozzles can be distributed optimally to the product particle surfaces kept at a distance.

Expressed in other words, as a result of the concentration of the quantities of air, substantially more intense fluidization is achieved in the region of the spray nozzles, which rules out undesired agglomeration or undesirably frequent encounters between the sprayed particles immediately in the region of the spray nozzle. This is seen as a considerable further contribution to the optimization of the treatment result.

In a further embodiment of the invention, the slots in the sections that run rectilinearly are closed at their outer circumferential ends.

This measure has the advantage that, in the region of the parallel end sections of the slots, no flow components are additionally applied from outside to inside along their longitudinal extent, instead only the opposed air streams directed toward each other transversely with respect to the rectilinear sections are formed.

In a further embodiment of the invention, the supply element of a spray nozzle is arranged outside of the components carrying the process air.

This measure has the advantage that the nozzle connecting element is not located in the process air stream and thus is not subjected to the temperature of the process air stream, so that the undesired supply of heat to the spray nozzle by process air can be ruled out.

In a further embodiment of the invention, provision is made to introduce the nozzles into the process chamber through the bottom laterally and standing obliquely upward.

This measure has the advantage that the nozzle supply element then stands laterally out from the outside of the container, so that said element is accessible from outside.

In a further embodiment of the invention, in an inflow chamber arranged under the bottom, an indentation is provided at the side, in which indentation the supply element of a spray nozzle is accommodated.

This measure has the advantage of arranging a spray nozzle also standing upright under the bottom. Because of the fundamental arrangement at the outer ends of the breaking-up zone, however, it is nevertheless then possible to make nozzle elements standing vertically also accessible from outside.

In a further embodiment of the invention, the respectively topmost guide plate is mounted at the desired vertical slot spacing from a lower end of a product container flange.

This measure has the advantage that this topmost guide plate can extend around the entire circumference and can be mounted at the constant distance, so that stepping the underside of the container or of the container flange is no longer necessary.

In a further embodiment of the invention, provision is made for a plate-like valve, which can be raised or lowered and by means of which a central emptying opening can be opened or closed, is provided in the bottom.

This measure has the advantage that the emptying of the product following treatment can be carried out simply through the bottom, specifically simply because the valve can be opened or closed and the product can be led away. In this case, the valve can be arranged centrally or else at the side. This is advantageous in particular in the case of very large plants, which can be tilted only with very great difficulty in order to empty them.

It goes without saying that the features mentioned above and those still to be explained below can be used not only in the combination respectively specified but also in other combinations or on their own without departing from the scope of the present invention.

### BRIEF DESCRIPTION OF THE DRAWINGS

The invention will be described in more detail and explained below using some selected exemplary embodiments in conjunction with the appended drawings, in which:

FIG. 1 shows a plan view of a bottom of a first exemplary embodiment of a device according to the invention;

FIG. 2 shows a section along the line II-II from FIG. 1;

FIG. 3 shows a much enlarged illustration of the right-hand outer section of the section of FIG. 2 during operation when treating a particulate material;

FIG. 4 shows an illustration corresponding to the left-hand outer region of the illustration of FIG. 1 of a further embodiment of a device according to the invention, having slots whose outer ends run rectilinearly;

FIG. 5 shows a section corresponding to the illustration of FIG. 2 along the line III-III from FIG. 4, an outer end section additionally being shown enlarged in a circle in FIG. 5;

FIG. 6 shows a plan view, comparable with the illustration of FIG. 1, of a bottom of a further embodiment of a device according to the invention;

FIG. 7 shows a vertical section of the device along the line VII-VII from FIG. 6;

FIG. 8 shows a much enlarged, circularly outlined section of the section of FIG. 7 in the central region of the bottom in an operating position when treating the material; and

FIG. 9 shows the corresponding illustration in the emptying mode.

### DETAILED DESCRIPTION OF PREFERRED EMBODIMENTS

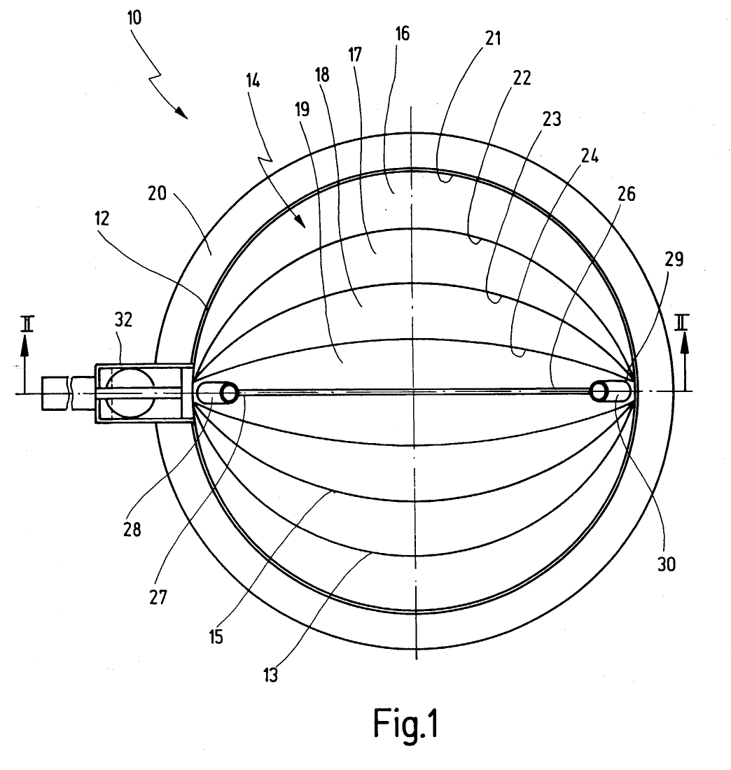

A first embodiment, shown in FIGS. 1 to 3, of a device according to the invention for treating particulate material is provided in its entirety with the number 10.

The device 10 has an upright hollow cylindrical container 12 which is provided with a bottom 14.

The bottom 14 is constructed from a series of guide plates 16, 17, 18 and 19 lying one above another.

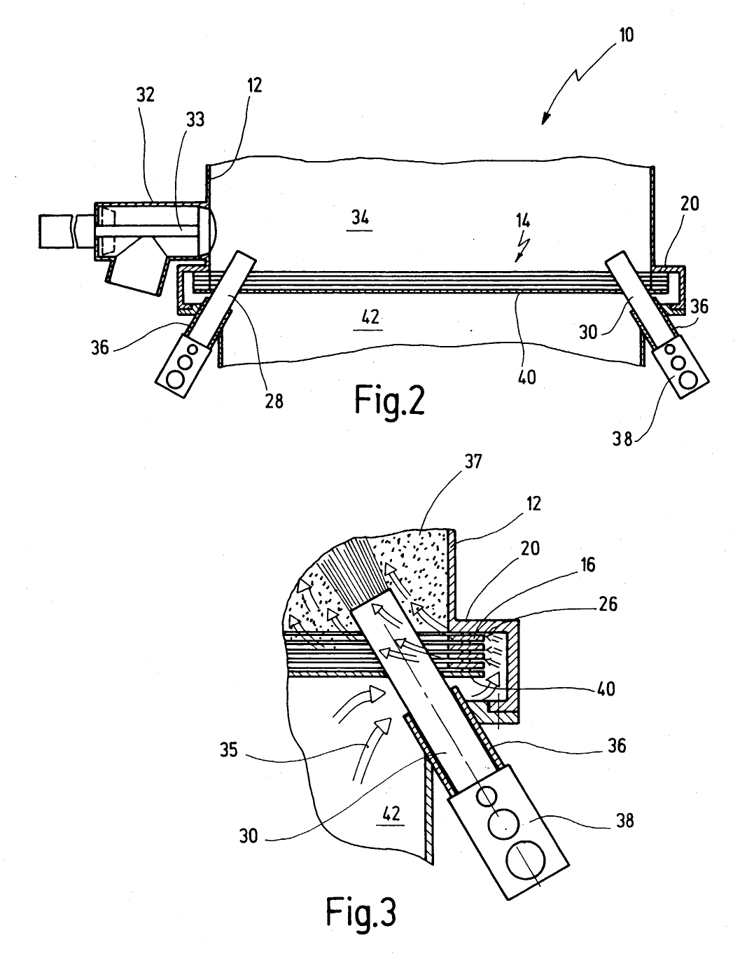

The topmost guide plate 16 is formed in such a way that it is circular at its outer circumference, and this reaches radially somewhat beyond the clear inner diameter of the cylindrical container 12, as can be seen in particular from the illustration of FIGS. 2 and 3.

This topmost flat guide plate 16 is arranged at a specific distance, about 1 to 2 mm, preferably 1.5 mm, underneath a flange 20 of the container 12, as can be seen in particular from FIG. 3.

The guide plate 16 ends radially in front of and at a distance from a vertical wall projecting upward and belonging to the flange 20.

As viewed in the plan view of FIG. 1, the result is that there is a first, approximately circular slot 21 in the region of the circumference of the container 12, through which process air 35, which comes from an inflow chamber 42 arranged underneath the bottom 14, can enter the interior of the container 12, that is to say the process chamber 34, as can be seen in particular from the flow arrows of FIG. 3.

A region is cut or punched centrally out of the guide plate 16 that has the shape of an ellipse 13, the main vertices of the ellipse 13 lying approximately at the level of the clear circumcircle of the cylindrical container 12.

Underneath the topmost guide plate 16 there is a further guide plate 17, in whose central region there is likewise an opening in the form of an ellipse 15, but this is substantially flatter than the ellipse 13. The main vertices of the ellipses 15 are also located where the main vertices of the ellipse 13 are located.

Thus, between the upper guide plate 16 and the guide plate 17 lying underneath it, there is a slot 22 having the contour of the ellipse 13.

Correspondingly, under the guide plate 17, a further guide plate 18 is then arranged, which likewise again has a central elliptical opening or punched-out portion, this being still flatter and its main vertex again lying in the region of the main vertices of the other ellipses 13 and 15. As a result, a further but still flatly elliptical slot 23 is then formed. Accordingly, between the guide plate 18 and the guide plate 19 lying underneath the latter, a further elliptical slot 24 is formed.

Provided in the guide plate 19 is a continuous slot which goes diametrically along a diameter and defines a breaking-up zone 26. A bottom plate 40 is located under the guide plate 19.

In the region in which the main vertices of the ellipsoidal slot 22, 23 and 24 run together, a nozzle 28 and 30 is respectively arranged.

As shown in particular by the sectional illustration of FIG. 2, the two diametrically opposite nozzles 28 and 30 stand obliquely upward and are in each case pushed into a guide 36.

This means that the supply elements 38 of the nozzles 28 and 30 lie outside the container 12 and the corresponding in-flow chamber 42, that is to say are not subjected to the direct influence of the warm process air 35.

The enlarged sectional illustration of FIG. 3 shows that the process air 35 coming from the inflow chamber 42 is guided laterally outward through the bottomplate 40 and then, directed from outside to inside over the entire circumference, enters through the slots, that is to say, for example, directed radially from outside to inside, through the outermost still circular slot 21, the process air passing through between the underside of the flange 20 and the upper side of the guide plate 16, as revealed in particular by FIG. 3. Accordingly, the process air 35 then passes through the slots 22, 23 and 24, which become more and more flatly elliptical. From this, two opposed opposite air streams are formed, which are moved toward each other and meet each other in the region of the breaking-up zone 26 and are deflected vertically upward.

The fact that the slots 21, 22, 23 and 24 are led together in the region of the nozzles 28 and 30 leads to a concentration of the quantity of process air in this region and therefore forms an additional outer process air cushion around the opening area of the nozzles 28 and 30, as can be seen in particular from FIG. 3. As a result, the intensely swirled material 37, in particular in the region of the nozzle opening, can be fluidized into such a state that the media sprayed by the respective nozzle 28 or 30 can meet individual fluidized material particles, the latter are kept at a relatively great distance for a relatively long time, so that the medium, depending on whether it is provided for granulating or for coating, can already assume a state, that is to say slight initial drying, in order in this way to lead to the highly uniform result.

The fact that the supply element 38 is arranged outside or to one side of the process air 35, removes this element from undesired heating by the process air, with the exception of the short section in which the process air flows around the nozzle.

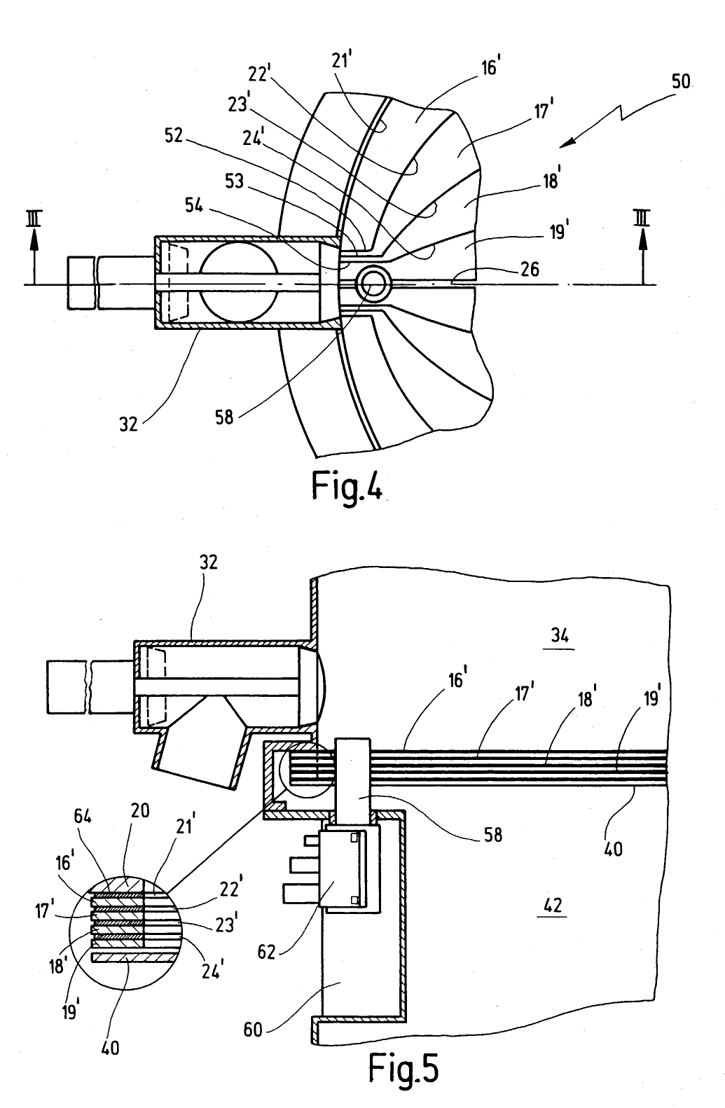

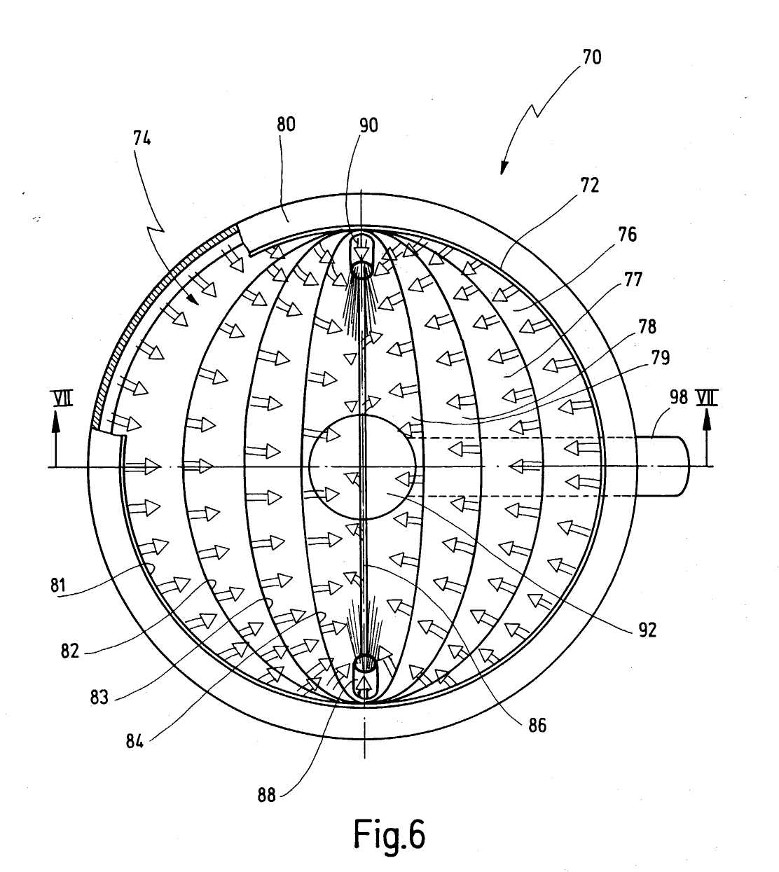

FIGS. 4 and 6 show a variant of a device for treating material which, in its entirety, is provided with the reference number 50.

The bottom shown there is constructed in virtually the same way as the bottom designated above in connection with FIG. 1, so that comparable components, that is to say in particular the guide plates, are provided with comparable reference numbers, the difference being shown here only by the identifying apostrophe.

As distinct from the embodiment shown in FIG. 1, the guide plates are cut out in such a way that, in the region of the nozzle 58, rectilinear sections are produced which run parallel to and at a distance from one another.

Accordingly, the topmost guide plate 16′ again has, in the region of a nozzle, here illustrated as nozzle 58, two opposite, rectilinear sections 52 which are arranged at a distance from each other and extend parallel to the central breaking-up zone 26. This means that the main vertex of the corresponding ellipse lies approximately centrally in the nozzle 58, and is followed by the rectilinear sections 52.

This then applies in a corresponding way to the punched-out sections of the guide plates 17′, 18′ and 19′ lying underneath, which likewise have corresponding rectilinear sections 53 and 54, which are stepped in such a way that these in each case then lie somewhat closer to the center of the nozzle 58.

In the rectilinear sections 52, 53 and 54 there are therefore slots from which the process air is guided diametrically oppositely to the nozzle 58.

It can be seen in particular from the sectional illustration of FIG. 5 that the nozzle 58 is arranged standing vertically in the bottom, and that its supply element 62 is arranged in a corresponding indentation 60 in the inflow chamber 42.

From the enlarged illustration surrounded by a circle in FIG. 5, it can be gathered that the radially outer ends of the rectilinear sections 52, 53 and 54 are closed, this being carried out simply by appropriate intermediate pieces being placed between the plates.

Accordingly, between the topmost guide plate 16′ and the underside of the flange 20, a corresponding intermediate piece 64 is then inserted. The same is then true of the plates lying underneath, that is to say between the guide plate 16′ and 17′ and, respectively, the guide plate 17′ and 18′, and also 18′ and 19′.

As a result, the rectilinear sections 52, 53 and 54 no longer have applied to them the flow component of process air that is directed along the diametrical longitudinal extent of the central breaking-up zone 26, but only the flow component directed in opposition to that previously described, that is to say at right angles to the rectilinear sections 52, 53 and 54.

In a further embodiment, described in FIGS. 6 to 9, of a device 70 according to the invention, the bottom, insofar as the geometry of the guide plates is concerned, is constructed in the same way as the exemplary embodiment described previously in connection with FIGS. 1 to 3.

The bottom 74 is thus constructed from the guide plates 76, 77, 78 and 79, which are mounted under the corresponding flange 80. Accordingly, there is then again an outer circular slot 81, which, as viewed inward, is followed by slots 82, 83 and 84 which become more and more flatly elliptical, and in the center there is again the rectilinear breaking-up zone 86 running over a diameter. Again, two nozzles 88 and 90 are then arranged in the region of the main vertices of the slots led together.

In the embodiments of FIGS. 1 to 5, the container 12 is emptied via a product emptying means 32 which projects radially at the side and is arranged a short distance above the bottom 14 and can be opened and closed via a valve 33.

In the embodiment shown in FIG. 6, the product emptying 92 takes place centrally.

For this purpose, a plate-like central valve 93 is provided, which is connected to an emptying pipe 98 led away laterally.

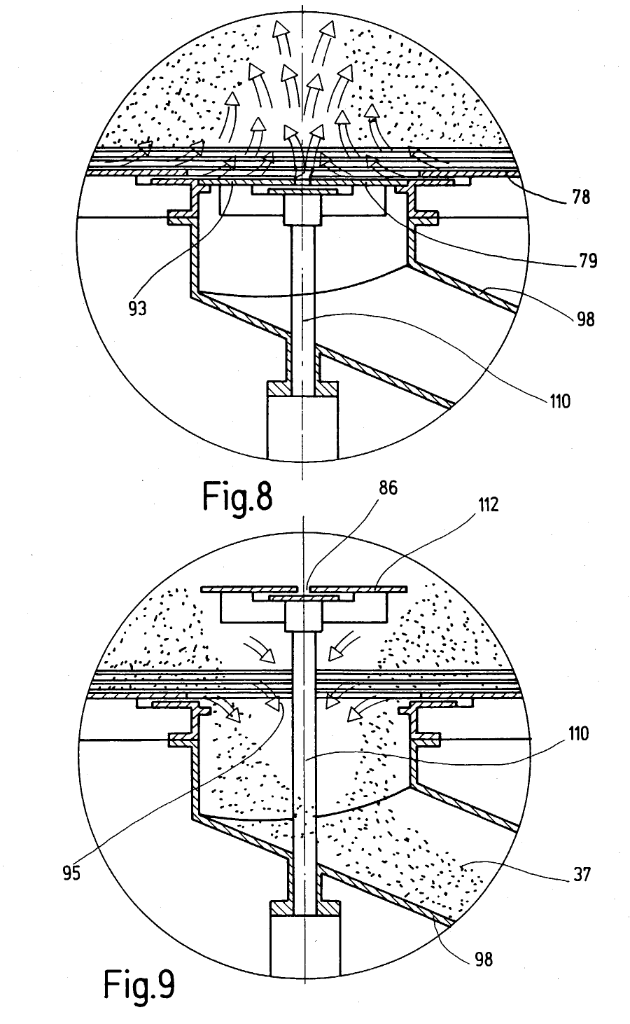

The plate-like valve 93 is therefore a constituent part of the bottom 74 of the device 70 and can be lifted for the purpose of emptying, for which purpose the plate 112 is connected to a plunger 110, as is illustrated by the change from FIGS. 8 and 9 or vice versa.

The radial spacing of the slots from a secondary vertex of the ellipses, as viewed inward, is around 30 to 70 mm.

If scaling up is carried out, a correspondingly larger number of guide plates is then needed in order to maintain this distance rule.

Nevertheless, it is sufficient to provide two diametrically opposite nozzles, in order to achieve an excellent treatment result, even in the event of scaling up.

One mode of operation can be seen from FIGS. 6 to 9.

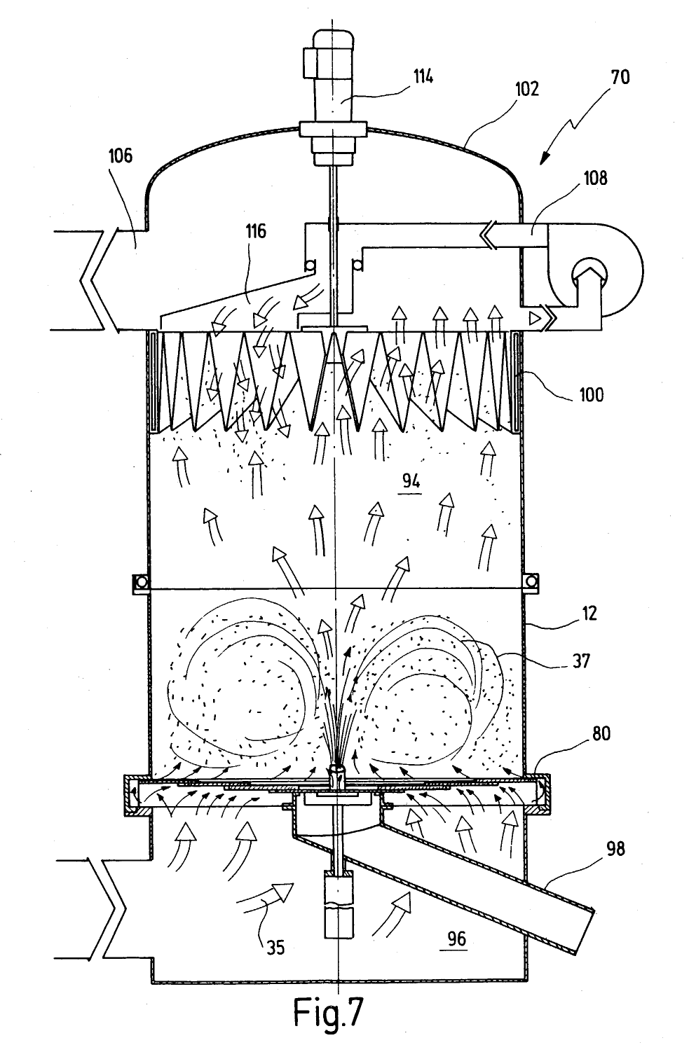

From the illustration of FIG. 7, it can be seen that the device 70, in addition to the cylindrical container 72 and the bottom 74, has an inflow chamber 96 arranged underneath, into which the process air 35 is introduced. The process air 35 is distributed uniformly and, from the outer circumferential side, is in each case guided, directed inward, between the slots 81, 82, 83 and 84, as can be seen in particular from the flow pattern of FIG. 6. It can also be seen from this that, in the region of the nozzles 88 and 90, more intensive boosted flow takes place, since there the slots run together.

In the breaking-up zone 86, the flows running in opposite directions meet each other and are led away directed vertically upward, as illustrated in particular in FIG. 7. In the process, the material 37 is intensively fluidized and can be treated optimally by the medium sprayed by the nozzles 88 and 90. The process air flows away upward into the process chamber 94, passes through a filter 100 in the process, and exits via an outlet 106 in a cover 102. Some of the process air is led away via a branch 108 and fed back on the countercurrent principle in order to clean the filter 100, as is known from the sector of this technology. A motor 114 rotates a rotating blow-off shoe 116 over the filter 100, so that the latter is continuously dedusted. The process air led away is then conditioned and subsequently fed back into the circuit of the inflow chamber 96 again. In order to empty the material 37 to be treated, the plate 112 is lifted via the plunger 110, as illustrated in FIG. 9, so that the product is then led away centrally via the emptying pipe 98, if appropriate with the aid of air in order to expel it.

What is claimed is:

1. A device for treating a particulate material, comprising
a process chamber for receiving and treating a particulate material with a process air,
a bottom of said process chamber is made of mutually overlapping guide plates, between which guide plates slots are formed allowing to enter said process air with a substantially horizontal movement into said process chamber,
said slots being arranged in such a way that two opposite flows of entering process air are directed toward each other, which meet along a breaking-up zone,
said slots being matched in an outer circumferential region of said bottom to an outer contour of said process chamber
and, as viewed radially inward, gradually approach to a contour of said breaking-up zone,
two spray nozzles being arranged at opposite ends of said breaking-up zone, and said slots running so as to be led together in a region of each of said two nozzles

2. The device of claim 1, wherein said outer contour of said process chamber is circular, said contour of said breaking-up zone is rectilinear and runs along a diameter of said circular process chamber, said slots gradually radially outwardly approach a circumcircle of said process chamber and gradually radially inwardly approach said rectilinear breaking-up zone along said diameter.

3. The device of claim 1, wherein said slots are led together approximately tangentially in said region of a spray nozzle.

4. The device of claim 1, wherein slots in said region of a spray nozzle have rectilinear sections which run parallel to said breaking-up zone.

5. The device of claim 4, wherein said guide plates lying one above another are set back in a manner of a staircase in said region of said rectilinear sections.

6. The device of claim 5, wherein said slots in said rectilinear section are closed at a outer circumferential end.

7. The device of claim 1, wherein supply elements of said spray nozzles are arranged outside of components carrying said process air.

8. The device of claim 1, wherein said spray nozzles can be inserted into said process chamber through said bottom laterally, standing obliquely upward.

9. The device of claim 1, wherein an inflow chamber being arranged under said bottom, said inflow chamber is provided with two indentations, in which indentation a supply element for supplying a nozzle is accommodated.

10. The device of claim 1, wherein a respective topmost guide plate is mounted at a desired vertical slot spacing from a lower end of a container flange of said process chamber.

11. The device of claim 1, wherein a plate-like valve, which can be raised or lowered and by means of which an emptying opening can be opened or closed, is provided within the bottom.
